(19) United States
(12) Patent Application Publication
(10) Pub. No.: US 2007/0168857 A1
(43) Pub. Date: Jul. 19, 2007

(54) Transformation of Source Data in a Source Markup Language to Target Data in a Target Markup Language

(75) Inventor: Indroniel Deb Roy, Hyderabad (IN)

Correspondence Address: LAW FIRM OF NAREN THAPPETA, 158, PHASE ONE PALM MEADOWS, RAMAGUNDANAHALLI, AIRPORT WHITEFIELD ROAD, BANGALORE, 560043, IN

(73) Assignee: ORACLE INTERNATIONAL CORPORATION, Redwood Shores (US)

(21) Appl. No.: 11/306,928

(22) Filed: Jan. 17, 2006

(51) Int. Cl. G06F 17/00

(52) U.S. Cl. 715/522; 715/513; 715/523

(57) ABSTRACT

Transforming source data in a source markup language to target data in a target markup language using transformation rules mapping source tags to corresponding target tags. In an embodiment, the tags in the source data (e.g., XML) are retrieved sequentially (e.g., by SAX parser) and hierarchical memory objects (e.g., DOM objects) are created for a source tag matching a transformation rule immediately upon reading the source tag. A portion of the target data corresponding to the source tag is then generated from the hierarchical memory objects. The hierarchical memory object may be removed from the memory once the corresponding portion of the target data is generated. As a result, the memory requirements may be reduced.

### BACKGROUND OF THE INVENTION

1. Field of the Invention

The present invention relates to markup languages, and more specifically to a method and apparatus facilitating a user to transform source data in a source markup language to target data in a target markup language.

2. Related Art

A markup language is a notation for writing text intermingled with markup instructions known as tags that indicate the role of the text, for example, about the text's structure (what the text signifies) or presentation. The text, whose role is specified by a tag, is conveniently referred to as content of the tag. An example of a markup language commonly used is the extensible markup language (XML).

There are several markup languages, potentially used to represent the same information. Such different markup languages provide different views of the same data/information by adding meaning to the way information is coded and processed. Different markup languages have evolved due to reasons such as historical evolution and lack of common standards.

There is often a need to transform data (“source data”) in one markup language to data (“target data”) in another markup language. Such a need may be presented due to applications requiring data in the corresponding markup language. Accordingly, if the source data is present in a different markup language, the target data needs to be generated in a target markup language consistent with the requirements of the application designed to process the information. Typically, a set of transformation rules is specified for mapping the source data in a source markup language to target data in a target markup language.

Several prior approaches are used to for transformation of source data to target data based on such transformation rules. In one prior approach, a parser generates a hierarchy of memory objects representing the entire source data sought to be transformed, and applies the set of transformation rules on the data in the memory objects to generate the target data. The memory objects are stored in a random access memory (RAM) and the hierarchy is often viewed as a Document Object Model (DOM), as is well known in the relevant arts.

One disadvantage with such an approach is that the RAM size requirement may be proportionate to the size of the source data (since the entire data is represented in the hierarchy), and the approach may not scale to transform source data of large size.

What is therefore needed is an approach, which addresses one or more problems described above.

### BRIEF DESCRIPTION OF THE DRAWINGS

The present invention will be described with reference to the accompanying drawings briefly described below.

FIG. 1 is a block diagram illustrating an example embodiment in which various aspects of the present invention are operative when software instructions are executed.

FIG. 2 is a flowchart illustrating the manner in which source data in a source markup language is transformed into target data in a target markup language according to an aspect of the present invention.

FIG. 3 depicts the content of source data specified in a source markup language in an illustrative example.

FIG. 4 depicts the content of a data model that contain a set of transformation rules mapping source data in a source markup language to target data in a target markup language in an illustrative example.

FIG. 5 depicts the content of target data specified in a target markup language generated in an illustrative example.

FIG. 6 depicts the hierarchy of memory objects generated from the source data when a mapping transformation rule is found in an embodiment of the present invention.

FIG. 7 is a flowchart illustrating the manner in which source data in a source markup language is transformed into target data in a target markup language when the transformation rules involve a function according to another aspect of the present invention.

FIG. 8 depicts the memory object generated/updated from the source data when a mapping transformation rule involving a function is found in the transformation rules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE PREFERRED EMBODIMENTS

1. Overview

According to an aspect of the present invention, a hierarchy of memory objects is created for a source tag when a transformation rule mapping the source tag to target data is found. The transformation rules and the created hierarchy of memory objects are then used to generate the target data (portion) corresponding to the content of the source tag. The created hierarchy of memory objects can potentially be removed soon after such transformation is completed. As a result, the transformation of source data to target data can be achieved with reduced memory requirements.

When a transformation rule involves a function of the source tag, a memory object is created the first time the source tag is found in the source data, and thereafter updated (based on the function) upon occurrence of the source tag with the same name in the source data. The target data corresponding to the function is generated from the memory object after all of the source data has been processed.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of the invention.

2. Digital Processing System

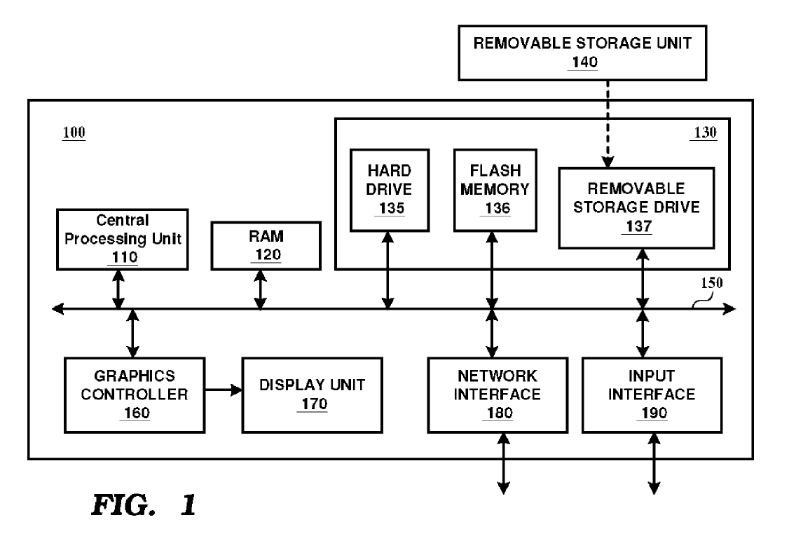

FIG. 1 is a block diagram illustrating the details of digital processing system 100 in which various aspects of the present invention are operative by execution of appropriate software instructions. Digital processing system 100 may contain one or more processors such as central processing unit (CPU) 110, random access memory (RAM) 120, secondary memory 130, graphics controller 160, display unit 170, network interface 180, and input interface 190. All the components except display unit 170 may communicate with each other over communication path 150, which may contain several buses as is well known in the relevant arts. The components of FIG. 1 are described below in further detail.

CPU 110 may execute instructions stored in RAM 120 to provide several features of the present invention. CPU 110 may contain multiple processing units, with each processing unit potentially being designed for a specific task. Alternatively, CPU 110 may contain only a single general purpose-processing unit. RAM 120 may receive instructions from secondary memory 130 using communication path 150.

Graphics controller 160 generates display signals (e.g., in RGB format) to display unit 170 based on data/instructions received from CPU 110. Display unit 170 contains a display screen to display the images defined by the display signals. Input interface 190 may correspond to a key-board and/or mouse. Network interface 180 provides connectivity to a network (e.g., using Internet Protocol), and may be used to communicate with other external systems (not shown), for example to receive/send source/target data.

Secondary memory 130 may contain hard drive 135, flash memory 136 and removable storage drive 137. Secondary memory 130 may store the data (e.g., the source data, target data, transformation rules, all described in sections below) and software instructions (causing desired transformation, described below), which enable digital processing system 100 to provide several features in accordance with the present invention. Some or all of the data and instructions may be provided on removable storage unit 140, and the data and instructions may be read and provided by removable storage drive 137 to CPU 110. Floppy drive, magnetic tape drive, CD-ROM drive, DVD Drive, Flash memory, removable memory chip (PCMCIA Card, EPROM) are examples of such removable storage drive 137.

Removable storage unit 140 may be implemented using medium and storage format compatible with removable storage drive 137 such that removable storage drive 137 can read the data and instructions. Thus, removable storage unit 140 includes a computer readable storage medium having stored therein computer software and/or data.

In this document, the term “computer program product” is used to generally refer to removable storage unit 140 or hard disk installed in hard drive 135. These computer program products are means for providing software to digital processing system 100. CPU 110 may retrieve the software instructions, and execute the instructions to provide various features of the present invention described below.

3. Transformation of Source Data to Target Data

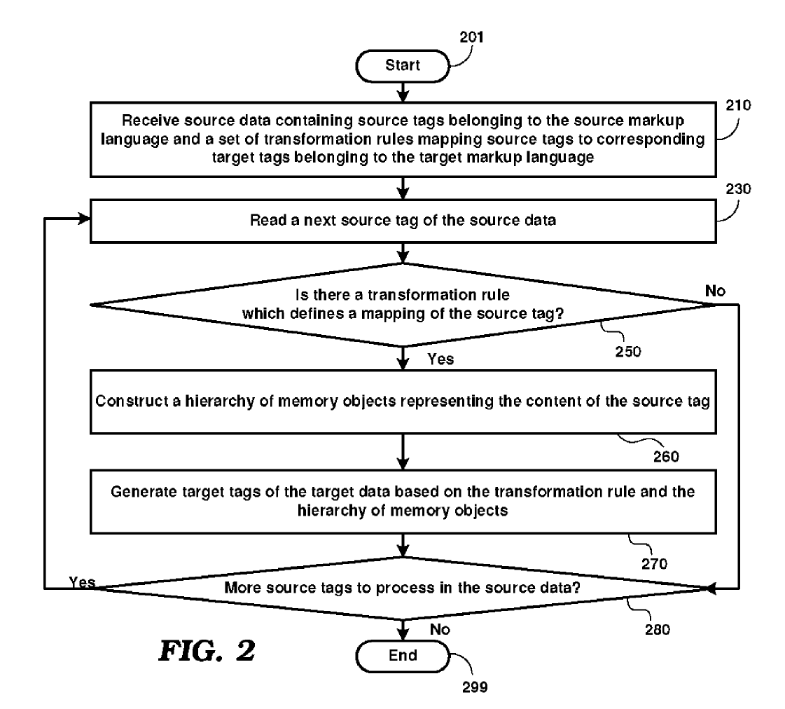

FIG. 2 is a flowchart illustrating the manner in which transformation of source data in a source markup language to target data in target markup language can be performed according to an aspect of the present invention. The flowchart is described with respect to FIG. 1 merely for illustration. The features can however be implemented in other types of systems/environments as will be apparent to one skilled in the relevant arts by reading the disclosure provided herein. The flowchart begins in step 201, in which control passes to step 210.

In step 210, digital processing system 100 receives source data containing source tags specified in a source markup language and a set of transformation rules mapping source tags to corresponding target tags belonging to the target markup language. The data may be received from external systems (via network interface 180) or from secondary storage 130 provided within digital processing system 100.

In step 230, digital processing system 100 reads a next source tag of the source data. In an embodiment, step 230 is implemented by using a SAX (simple API for XML) parser well known in the relevant arts. SAX parser is described in further detail in the book titled “SAX2” by David Brownell, published by O'Reilly with ISBN 0-596-00237-8.

In step 250, digital processing system 100 checks whether there is a transformation rule defining a mapping of the source tag. Control passes to step 260 if a mapping is found, and to step 280 otherwise.

In step 260, digital processing system 100 constructs a hierarchy of memory objects representing the content of the source tag. The content can include text, other tags and any other information specified by the source markup language. Inputs (source tags in the content) may be received from the SAX parser and a DOM (hierarchy of memory objects) may be created from the inputs in a known way.

In step 270, digital processing system 100 generates target tags of the target data based on the transformation rule and the hierarchy of memory objects. In step 280, digital processing system 100 checks whether there are additional source tags in the source data for processing. Control passes to step 230 if more source tags are found, and to step 299 otherwise. The flowchart ends in step 299.

It may thus be appreciated that the flowchart of FIG. 2 provides an approach using which source data is converted to target data. The memory requirements in such conversion may be reduced since the hierarchy of memory objects is constructed only for a source tag presently being processed/transformed. The features are illustrated with respect to examples below.

4. Illustration

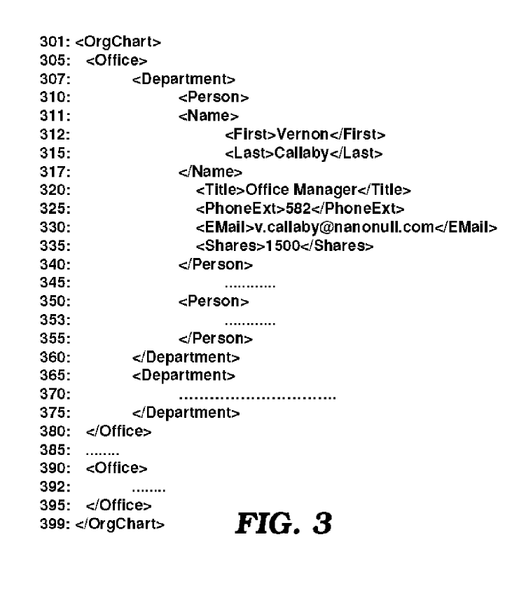

FIGS. 3, 4 and 5 together are used to illustrate the manner in which the approach(es) of FIG. 2 can be used to transform source data in a source markup language to target data in a target markup language. Each Figure is described below in further detail.

FIG. 3 depicts the contents of a source document containing the source data in XML. Lines 310-340 specify a source tag “<Person>” that needs to be transformed and can be uniquely identified using its name “Person” or by a path (containing a set of names of tags) from the beginning of the source data “/OrgChart/Office/Department/Person”. The end of the content of the source tag is depicted by “</Person>”. As may be appreciated, the content of source tag “<Person>” contains other tags —“<Name>” (lines 311-317), “<Title>” (line 320), etc. Lines 350 to 355 specify another tag with the same role as the source tag of lines 310-340.

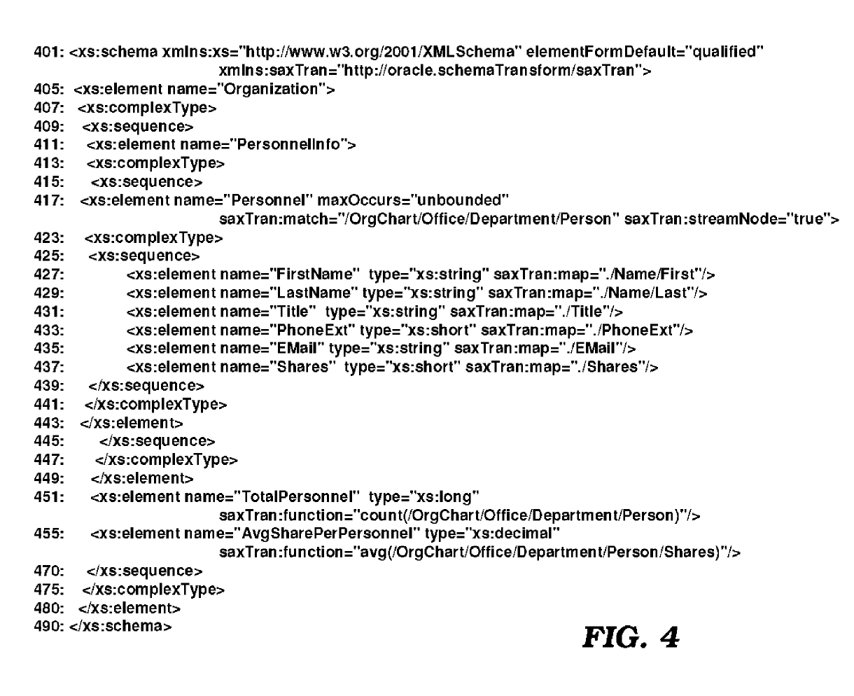

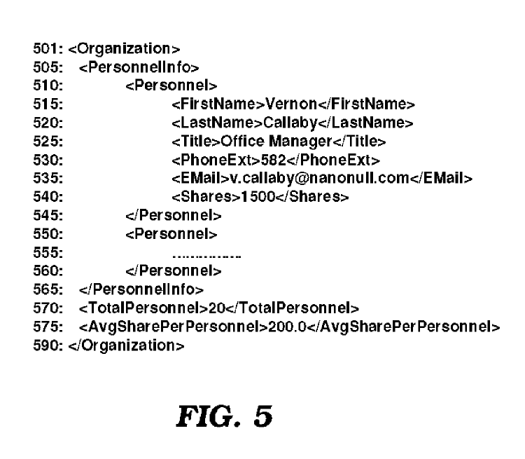

FIG. 4 depicts the contents of an XML Schema file that contains the transformation rules mapping the source data shown in FIG. 3 to the target data shown in FIG. 5. Lines 417 to 443 specify a mapping from the “OrgChart/Office/Department/Person” in the source data to tag named “Personnel” in the target data. Line 451 specifies another transformation rule where the mapping involves a function “count(/OrgChart/Office/Department/Person)” which counts the number of occurrences of “/OrgChart/Office/Department/Person” in the source data.

Also, different functions may be used in specifying transformation rules (e.g., count, avg (average)). In general, functions require examination of the remaining/entire source data, and thus the corresponding details may need to be created/maintained in memory as the source data is being processed. The target data corresponding to functions is thus generally generated after the entire source data has been processed in the embodiments described herein.

It may be appreciated that the transformation rules are a part of the data model in the example of FIG. 4. Due to such an arrangement, the information necessary for validating the target data is also present in the same file as the transformation rules, thereby facilitating implementation of a parser that generates (from source data) as well as validates the target data together.

FIG. 5 depicts the contents of target document containing the target data in XML generated from the source data shown in FIG. 3 and the transformation rules specified in the XML Schema of FIG. 4. Lines 510 to 545 represent the target data generated by applying the transformation rules specified in Lines 417 to 443. Line 570 represents the output of the function generated by applying the transformation rule specified in Line 451.

The description is continued with respect to the manner in which the content of FIG. 5 can be generated from the source data of FIG. 3 and the transformation rules specified in FIG. 4 using the approach of FIG. 2.

5. Transformation of Hierarchical Data

Continuing with combined reference to FIGS. 1-5, digital processing system 100 reads a next source tag “<OrgChart>” as per step 230. In step 250, digital processing system 100 tries to find a transformation rule with the name “OrgChart” of the tag or a path “/OrgChart” to the tag. Control is passed to step 280 as no transformation rule can be found. Digital processing system 100 then checks whether the source XML document has any more source tags to read as per step 280. Control is passed to step 230, as more source tags are available.

Digital processing system 100 reads a next source tag “<Office>” and the above-described process is repeated for the tags “<Office>” and “<Department>” since both these tags are not specified in any transformation rule.

Digital processing system 100 reads a next source tag “<Person>” as per step 230. In step 250, digital processing system 100 finds a transformation rules (Line 417) that has specified a path “/OrgChart/Office/Department/Person” to the source tag. Digital processing system 100 reads the source data 610 (lines 310 to 340) from the source tag “<Person>” to the corresponding end tag “</Person>” and constructs a hierarchy of memory objects (containing all the tags and the content/text of the tags in a hierarchical manner) in secondary memory 130 as per step 260. In an embodiment, the hierarchy of memory objects can be viewed as a DOM, as described in the below section.

As per step 270, applying the transformation rules specified in Lines 417 to 443 to the hierarchy of memory objects generates target (Lines 510 to 545), as also described in the section below. The manner, in which the target data is generated, is described below.

6. Hierarchical Memory Objects and Transformation

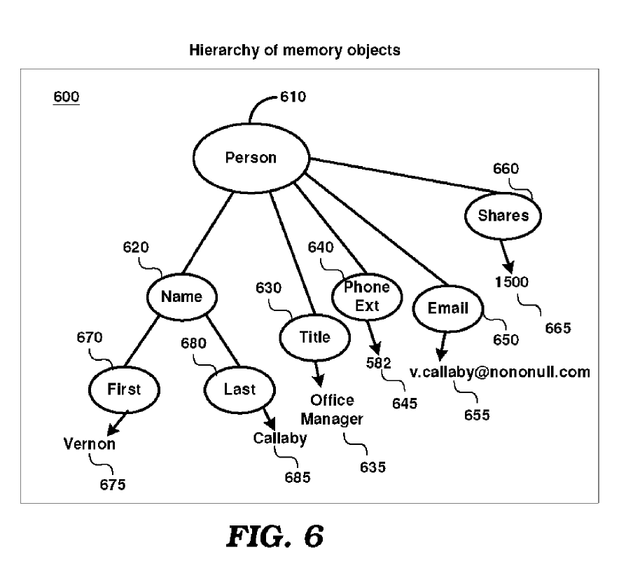

FIG. 6 depicts the hierarchy of memory objects (600) created from source data (lines 310-340) upon finding a transformation rule matching source tag “<Person>”. As may be readily observed, the hierarchical structure 600 represents the same hierarchy in source data. For example, tag “<Name>” (of line 311) being present in the content of the source tag “<Person>” is constructed to be an immediate child node 620 to node 610 representing source tag “<Person>”.

Similarly, nodes 670 and 680 representing tags “<First>” and “<Last>” (lines 312 and 315 respectively) are constructed to be immediate children of node 620 by virtue of the fact that the two tags are within the content (of lines 311-317) of tag “<Name>”. Text “Vernon” (line 312) that forms the content of the tag “<First>” is constructed as an immediate child node 675 (leaf) to node 670 representing tag “<First”>. Similarly, nodes 635 and 645 representing the texts “Office Manager” and “582” are constructed as immediate children for the nodes 630 and 640 representing the tags “<Title>” and “<PhoneExt>” respectively.

Thus, digital processing system 100 receives the parsed tags of the source data and constructs a hierarchy of memory objects representing the source data, as described above. The memory objects may be stored in RAM 120. The objects can then be examined to generate the target data as per the transformation rules, as described below.

The transformation rule containing the source tag is examined to generate the target data. The processing necessary for generating the target data depends on the type of transformation rule. For example, some transformation rules would simply specify the mapping of name/path of a source tag to a target tag, in which case the target tag and its corresponding end tag would be generated in the target data.

As an illustration, the transformation rule specified in line 417 maps the source tag with path “OrgChart/Office/Department/Person” in the source data to tag named “Personnel” in the target data. As a result, a tag “<Personnel>” is generated in the target data (line 510) along with a corresponding end tag “</Personnel>” (line 545).

To generate the target data corresponding to the source tags such as “<Person>”, it should be first appreciated that the content of such tags contain several more tags. The transformation rules for the source tag may be associated with a set of related transformation rules, which map the tags contained in the content of the source tag to the corresponding target data. The target data may be generated from the related transformation rules (contained associated with the transformation rule matching the source tag) and the hierarchy of memory objects.

As an illustration, applying transformation rule in line 417 generates the target tag “(Personnel)”, and the content of tag “<Personnel>” may be generated by applying the related transformation rules specified in lines 423-443 by using hierarchy of memory objects 600 as described below.

Another transformation rule may specify mapping from a path in hierarchy of memory objects 600 to target data. Often the path is specified in relation to a specific source tag in the source data. As an illustration, transformation rule specified in Line 427 maps the source tag with path “./Name/First” to the target tag “FirstName”. The “.” at the beginning of the path specifies the root (node 610) of hierarchy of memory objects 600. Hierarchy of memory objects 600 is searched for a path “./Name/First” (node 670) and the contents “Vernon” (node 675) is retrieved to generate the target data. As a result, a tag “<FirstName>” is generated in the target data with a corresponding end tag “</FirstName>”, the content of the tag being “Vernon”. The resultant generated target data is shown in line 515.

Similarly, target data (lines 520 to 540) is generated from hierarchy of memory objects 600 from the transformation rules specified in lines 429 to 437 specifying mappings from paths in the hierarchy of memory objects 600 to target data.

After the transformation rules (lines 417 to 443) have been used to generate the target data, hierarchy of memory objects 600 can be removed from memory, thereby reducing the overall memory size requirement.

It may be appreciated that a source tag can map to multiple transformation rules, and target data is generated for each of the mapped transformation rules. The same hierarchy of memory objects 600 can be conveniently used, if the processing requirements permit such optimization. The necessary processing depends on the type of transformation rule. The description is continued with respect to a transformation rule involving a function.

7. Transformation Involving a Function

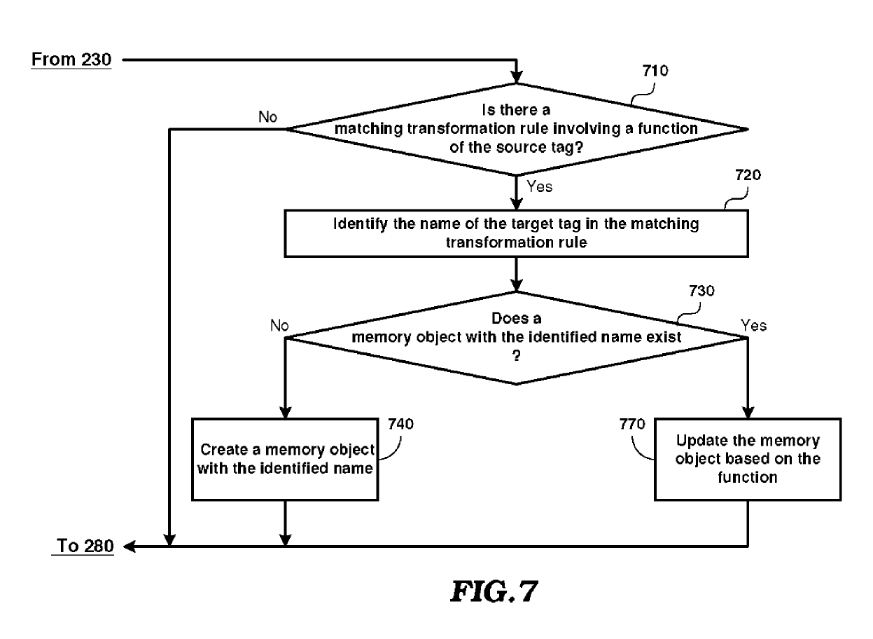

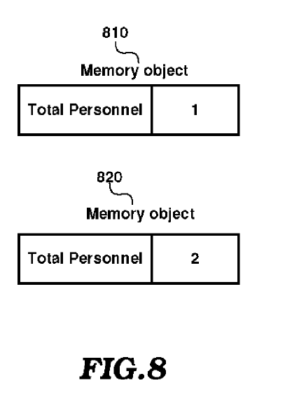

FIGS. 7 and 8 together illustrate the manner in which transformation of source data to target data may be achieved when a matching transformation rule involves a function. In particular, FIG. 7 contains a flow chart illustrating the steps and FIG. 8 depicts a memory object (810) created/updated during the process of transforming the source data to target data. It may be appreciated that the steps of FIG. 7, explained in detail below, may be done in parallel to (or in addition to) the step 250 to 270 in FIG. 2.

In step 710, digital processing system 100 checks whether there is a transformation rule involving a function of the source tag and also matching the source tag. Control passes to step 720 if such matching transformation rule is found, and to step 280 otherwise. For example, line 451 specifies a transformation rule where the transformation rule involves a function “count(/OrgChart/Office/Department/Person)” which counts the number of occurrences of the source tag “/OrgChart/Office/Department/Person” in the source data.

In step 720, digital processing system 100 identifies the name of the target tag to be generated specified by the matching transformation rule. For example, line 451 specifies that the name of the target tag to be generated is “TotalPersonnel”.

In step 730, digital processing system 100 determines whether a memory object with the identified name already exists in memory (RAM 120). Control passes to step 740 if the memory object is not found, and to step 770 otherwise.

In step740, digital processing system 100 creates a memory object 810 with the name of the target tag. For example, as per transformation rule specified in line 451, memory object 810 with the target tag name “TotalPersonnel” is created, when the source tag in line 310 is read. Control then passes to step 280 to process the next source tag.

In step 770, digital processing system 100 updates the memory object based on the function involved in the transformation rule. For example, when the source tag in line 350 is read, memory object 810 is updated by incrementing the value by 1 (as the function “count” counts the number of occurrences), thereby causing memory object 820 to be formed. Control then passes to step 280 to process the next source tag.

Thus, the flow-chart of FIG. 7 operates to generate aggregated information based on several tags in the source data, and the target tags containing the final results are generated once all the source tags are processed (e.g., between steps 280 and 299 of FIG. 2). The target data generated corresponding to “TotalPersonnel” is shown in line 570.

Accordingly, the various features of the present invention enable the transformation of source data in a source markup language to target data in a target markup language. It may be appreciated that the transformation rules are specified along with the data model in FIG. 4. Since the data model specifies the (desired or ‘valid’) syntax for the target markup language, the target data generated may comply with the specified syntax precisely.

While both the source and target markup languages are identical in the above described embodiments, it should be appreciated that the features described above can be extended to environments in which the source and target markup languages are different, as will be apparent to one skilled in the relevant arts by reading the disclosure provided herein.

8. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents. Also, the various aspects, features, components and/or embodiments of the present invention described above may be embodied singly or in any combination in a data storage system such as a database system.

What is claimed is:

1. A method of transforming a source data in a source markup language to target data in a target markup language, said source data containing a plurality of source tags belonging to said source markup language, said method comprising:
receiving said source data and a set of transformation rules, wherein each of said set of transformation rules maps a corresponding one of said plurality of source tags to a corresponding one of a plurality of target tags, said plurality of target tags belonging to said target markup language;
reading a next source tag from said source data;
determining a mapping transformation rule defining a mapping of said next source tag upon reading said next source tag, wherein said mapping transformation rule is contained in said set of transformation rules;
constructing a hierarchy of memory objects representing a content of said next source tag upon determining said mapping transformation rule; and
generating said target data based on said mapping transformation rule and said hierarchy of memory objects.

2. The method of claim 1, wherein said set of transformation rules is specified as a part of a data model defining said target data.

3. The method of claim 1, wherein said content comprises a second plurality of source tags and a second plurality of text values specified according to a hierarchy, wherein said constructing said hierarchy of memory objects comprises forming said hierarchy of memory objects according to said hierarchy, wherein said hierarchy of memory objects comprises a plurality of nodes corresponding to said second plurality of source tags and said second plurality of text values.

4. The method of claim 3, wherein said next source tag is uniquely identified by a path indicating a position in said source data, wherein said determining comprises comparing said path to said set of transformation rules.

5. The method of claim 4, wherein said set of transformation rules contains a subset of transformation rules associated with said mapping transformation rule, wherein each of said subset of transformation rules maps each of said second plurality of source tags to corresponding target tags, wherein said generating generates said target data according to said subset of transformation rules.

6. The method of claim 5, wherein at least one of said subset of transformation rules contains a path indicating a position relative to said next source tag.

7. The method of claim 1, wherein said set of transformation rules further contains a function transformation rule involving a function of said next source tag and mapping to a target tag, said method further comprises:
checking whether a memory object with a name of said target tag already exist;
updating said memory object with said function if said memory object already exists; and
creating said memory object with said function if said memory object already does not exist,
wherein said generating generates additional part of said source data from said memory object after all of said source data is processed.

8. A computer readable medium carrying one or more sequences of instructions for causing a system to transform a source data in a source markup language to target data in a target markup language, said source data containing a plurality of source tags belonging to said source markup language, wherein execution of said one or more sequences of instructions by one or more processors contained in said system causes said one or more processors to perform the actions of:
receiving said source data and a set of transformation rules, wherein each of said set of transformation rules maps a corresponding one of said plurality of source tags to a corresponding one of a plurality of target tags, said plurality of target tags belonging to said target markup language;
reading a next source tag from said source data;
determining a mapping transformation rule defining a mapping of said next source tag upon reading said next source tag, wherein said mapping transformation rule is contained in said set of transformation rules;
constructing a hierarchy of memory objects representing a content of said next source tag upon determining said mapping transformation rule; and
generating said target data based on said mapping transformation rule and said hierarchy of memory objects.

9. The computer readable medium of claim 8, wherein said set of transformation rules is specified as a part of a data model defining said target data.

10. The computer readable medium of claim 8, wherein said content comprises a second plurality of source tags and a second plurality of text values specified according to a hierarchy, wherein said constructing said hierarchy of memory objects comprises forming said hierarchy of memory objects according to said hierarchy, wherein said hierarchy of memory objects comprises a plurality of nodes corresponding to said second plurality of source tags and said second plurality of text values.

11. The computer readable medium of claim 10, wherein said next source tag is uniquely identified by a path indicating a position in said source data, wherein said determining comprises comparing said path to said set of transformation rules.

12. The computer readable medium of claim 11, wherein said set of transformation rules contains a subset of transformation rules associated with said mapping transformation rule, wherein each of said subset of transformation rules maps each of said second plurality of source tags to corresponding target tags, wherein said generating generates said target data according to said subset of transformation rules.

13. The computer readable medium of claim 12, wherein at least one of said subset of transformation rules contains a path indicating a position relative to said next source tag.

14. The computer readable medium of claim 8, wherein said set of transformation rules further contains a function transformation rule involving a function of said next source tag and mapping to a target tag, further comprises:
checking whether a memory object with a name of said target tag already exist;
updating said memory object with said function if said memory object already exists; and
creating said memory object with said function if said memory object already does not exist,
wherein said generating generates additional part of said source data from said memory object after all of said source data is processed.

15. A system transforming a source data in a source markup language to target data in a target markup language, said source data containing a plurality of source tags belonging to said source markup language, said system comprising:
means for receiving said source data and a set of transformation rules, wherein each of said set of transformation rules maps a corresponding one of said plurality of source tags to a corresponding one of a plurality of target tags, said plurality of target tags belonging to said target markup language;
means for reading a next source tag from said source data;
means for determining a mapping transformation rule defining a mapping of said next source tag upon reading said next source tag, wherein said mapping transformation rule is contained in said set of transformation rules;
means for constructing a hierarchy of memory objects representing a content of said next source tag upon determining said mapping transformation rule; and
means for generating said target data based on said mapping transformation rule and said hierarchy of memory objects.

16. The system of claim 15, wherein said set of transformation rules is specified as a part of a data model defining said target data.

17. The system of claim 16, wherein said content comprises a second plurality of source tags and a second plurality of text values specified according to a hierarchy, wherein said means for constructing said hierarchy of memory objects comprises forming said hierarchy of memory objects according to said hierarchy, wherein said hierarchy of memory objects comprises a plurality of nodes corresponding to said second plurality of source tags and said second plurality of text values.

18. The system of claim 17, wherein said next source tag is uniquely identified by a path indicating a position in said source data, wherein said means for determining comprises comparing said path to said set of transformation rules.

19. The system of claim 18, wherein said set of transformation rules contains a subset of transformation rules associated with said mapping transformation rule, wherein each of said subset of transformation rules maps each of said second plurality of source tags to corresponding target tags, wherein said means for generating generates said target data according to said subset of transformation rules.

20. The system of claim 15, wherein said set of transformation rules further contains a function transformation rule involving a function of said next source tag and mapping to a target tag, said system further comprises:
means for checking whether a memory object with a name of said target tag already exist;
means for updating said memory object with said function if said memory object already exists; and
means for creating said memory object with said function if said memory object already does not exist,
wherein said means for generating generates additional part of said source data from said memory object after all of said source data is processed.
